(19) United States
(12) Patent Application Publication
(10) Pub. No.: US 2024/0108158 A1
(43) Pub. Date: Apr. 4, 2024

(54) TREE COLLAR APPARATUS AND METHOD

(71) Applicant: Margaret Henz, Cincinnati, OH (US)

(72) Inventor: Margaret Henz, Cincinnati, OH (US)

(21) Appl. No.: 17/958,389

(22) Filed: Oct. 1, 2022

(51) Int. Cl. A47G 33/12; B32B 5/02; B32B 5/26; B32B 7/06; B32B 7/09; B32B 29/02; B32B 29/08

(52) U.S. Cl. CPC A47G 33/12; B32B 5/02; B32B 5/26; B32B 7/06; B32B 7/09; B32B 29/02; B32B 29/08; A47G 2033/1266; B32B 2260/021; B32B 2260/04; B32B 2451/00

(57) ABSTRACT

A tree collar apparatus (100) and method (900) that uses highly modular panels (200) that can be connected together by the wire assemblies (300) positioned within one or more sheaths (280) in the panels (200).

### BACKGROUND OF THE INVENTION

The invention relates generally to apparatuses and methods for covering a base of a tree. More specifically, the invention is a tree collar apparatus and method (collectively, the “tree collar apparatus” or simply “apparatus”).

In the modern era, the tree collar and their close cousin, the tree skirt, share a common objective of covering the base of a tree which is typically held up with a tree stand or similar structure. The primary purpose of such devices is improved visual aesthetics.

The use tree skirts traces back at least as far as Germany in the 1870s where rudimentary tree skirts were used to collect the hot wax which dripped from the candles used to light Christmas trees. Tree collars appear to have a far more recent origin. Many attributes of a family Christmas tree have changed in the years since the initial introduction of tree skirts. According to a 2018 survey by American Christmas Tree Association, 82% of Christmas trees in the United States are artificial trees. The vast majority of households now use electrical lights rather than lit candles to light their trees.

Different tree stands can be differentiated from each other based on rigidity, material composition, weight, ease of assembly and disassembly, size of the footprint in a retail or storage setting, cost, and durability.

According to the National Retail Federation, spending over the Christmas holiday increased by 45% over the decade leading up 2019, where such spending reached $729.1 billion in 2019.

The apparatus is described in greater detail below in the Summary of the Invention section.

### SUMMARY OF THE INVENTION

The invention relates generally to apparatuses and methods for covering a base of a tree. More specifically, the invention is a tree collar apparatus and method (collectively, the “tree collar apparatus” or simply “apparatus”).

The apparatus can be implemented as a combination of multiple curved panels that can be easily stacked when in an unassembled state. The panels can be connected to each other through the connection of wire assemblies that are secured within sheaths connect to the panels.

The various pieces of the apparatus can be highly modular, interchangeable and even identical.

The pieces of the apparatus can remain curved when in an unassembled state. Curved panels are useful in forming an aggregate apparatus that has a curved shape. It is also advantageous with respect to storing the unassembled apparatus on while being transported, while on store shelves, or while being stored in the basement of a family home. Multiple curved panels can stand independently upright on a shelf at a retail store enabling the everyday consumer to easily understand the product without expensive packaging.

The apparatus can be better understood by referencing the drawings discussed below.

### BRIEF DESCRIPTION OF THE DRAWINGS

Different examples of various attributes, components, and configurations that can be incorporated into the apparatus are illustrated in the drawings described briefly below. No patent application can expressly disclose in words or in drawings, all of the potential embodiments of an invention. In accordance with the provisions of the patent statutes, the principles, functions, and modes of operation of the system are illustrated in certain preferred embodiments. However, it must be understood that the apparatus may be practiced otherwise than is specifically illustrated without departing from its spirit or scope.

FIG. 1A is an environmental diagram illustrating an example of a tree where a tree collar apparatus is positioned to cover the base of the tree.

FIG. 1B is a block diagram illustrating an example of the components of the apparatus.

FIG. 1C is a perspective view of an assembled tree collar apparatus.

FIG. 2A is a block diagram illustrating an example of the components that can comprise the apparatus, particularly the components that can be included within the panels of the apparatus.

FIG. 2B is a perspective view illustrating an example of a curved panel comprised by an inner layer encased in two coverings.

FIG. 2C is a perspective view illustrating an example of a panel with two sheaths.

FIG. 2D is a perspective view illustration similar to FIG. 2C, with the difference being that the example in FIG. 2D shows wire assembly components positioned within the sheaths.

FIG. 2E is a perspective view illustration similar to that of FIG. 2D, with the difference being that the example in FIG. 2D shows the addition of panel fasteners and where the wire is visible through the sheath.

FIG. 3A is a block diagram illustration is a block diagram illustrating an example of the components that can comprise the apparatus, particularly the components that can be included within the wire assembly of the apparatus.

FIG. 3B is a perspective view illustrating an example of the wire assembly components on an assembled apparatus.

FIG. 3C is a perspective view illustrating an example of the mating components of the wire assembly.

FIG. 4A is a block diagram illustrating an example of an apparatus that includes an option decorative assembly.

FIG. 4B is an environmental diagram illustrating an example of a decorative fastener attached to the exterior surface of the tree collar apparatus.

FIG. 4C is an environmental diagram illustrating an example of the apparatus in FIG. 4B where a patch is removably attached to the exterior surface of the tree collar apparatus.

FIG. 5A is a flow chart diagram illustrating an example for assembling and setting up the apparatus.

FIG. 5B is a flow chart diagram illustrating an example of removing and disassembling the apparatus.

The apparatus can be further understood by the text description provided below in the Detailed Description section.

### DETAILED DESCRIPTION

The invention relates generally to apparatuses and methods for covering a base of a tree. More specifically, the invention is a tree collar apparatus and method (collectively, the “tree collar apparatus” or simply “apparatus”).

### I. Glossary of Terms

All terminology associated with an element number is defined in Table 1 below.

TABLE 1

| # | Name | Definition/Description |
|---|---|---|
| 40 | User | A human being responsible for assembling and |
| | | disassembling the apparatus 100. |
| 50 | Material | The type of matter of which something is made. |
| | | Examples of materials 50 that can potentially be |
| | | included in the apparatus 100 can include metals 52, |
| | | fabrics 54, cardboard 56 plastic 58, wood 60, clay 62, |
| | | and ceramic 63. |
| 52 | Metal | A class of materials 50 characterized by malleability, |
| | | ductility, reflectivity, and high electrical and thermal |
| | | conductivity. |
| 53 | Solder | A low melting metal 52 that is melted to join metallic |
| | | surfaces. |
| 54 | Fabric | A cloth or other material 50 produced by weaving or |
| | | pressing together one or more of the following: (a) |
| | | natural fibers; (b) manmade fibers; (c) cotton; (d) |
| | | nylon; (e) wool; (f) silk; and/or (g) other kinds of |
| | | woven or unwoven threads. |
| 56 | Cardboard | A material 50 made from a cellulose fiber such as |
| | | wood pulp such as paper but thicker. Cardboard 56 |
| | | includes but is not limited to paperboard and |
| | | corrugated fiberboard. |
| 58 | Plastic | A synthetic material 50 made from a wide range of |
| | | organic polymers such as polyethylene, PVC, nylon, |
| | | etc. |
| 60 | Wood | A hard fibrous material that forms the main substance |
| | | of the trunk or branches of a natural tree 92 or natural |
| | | shrub. |
| 62 | Clay | Thick heavy earth that is plastic when wet and hard |
| | | when dry or baked. |
| 63 | Ceramic | Clay 62 that has been hardened by heat. |
| 80 | Base | A device that supports a tree 90, keeping the tree 90 |
| | | in an upright position. |
| 90 | Tree | A natural tree 92 or an artificial tree 94. In many |
| | | instances, the apparatus 100 will be used with |
| | | respect to an indoor Christmas tree but variations of |
| | | the apparatus 100 can be used in other contexts. |
| 92 | Natural Tree | A long-lived woody plant that typically has a singular |
| | | and relatively tall lower potion. |
| 94 | Artificial Tree | A man-made structure with the aesthetic appearance |
| | | of a natural tree 92. Artificial trees 94 are typically |
| | | comprised of plastic 58. |
| 100 | Apparatus | A collective configuration of panels 200 and wire |
| | | assemblies 300 that collectively function as a “tree |
| | | collar” for a tree 90. |
| 200 | Panel | A collective configuration of components, typically |
| | | including an inner layer 250, a fabric covering 260, |
| | | and a sheath 280. |
| 210 | Curved Panel | A panel 200 that is non-straight. In a preferred |
| | | embodiment of the apparatus 100, the panels 200 are |
| | | curved panels 210 and remain as curved panels 210 |
| | | when in an assembled state 810 or a disassembled |
| | | state 850 |
| 220 | Modular Panel | In a preferred embodiment of the apparatus 100, all |
| | | of the panels 200 are identical to each other such that |
| | | modularity is maximized. |
| 250 | Inner Layer | A substrate forming the general shape of the panel |
| | | 200. The inner layer 250 can be comprised of a wide |
| | | variety of materials 50. In a preferred embodiment, |
| | | the inner layer 250 is a carboard layer 252. In other |
| | | embodiments, other semi-rigid materials 50 can be |
| | | used such as a flexible non-molded plastic sheet, |
| | | semi-rigid fabric, or flexible metal sheet. |
| 252 | Cardboard Layer | An inner layer 250 comprised of cardboard 56. |
| 260 | Covering | A substrate or sheet that covers the inner layer 250. |
| | | The covering 260 can be comprised of any material |
| | | 50. In a preferred embodiment, the covering 260 is |
| | | comprised of fabric 54. In some embodiments, there |
| | | is a covering 260 on each said of the inner layer 250, |
| | | while in other embodiments only the exterior facing |
| | | surface has a covering 260. |
| 262 | Fabric Covering | A covering 260 comprised of fabric 54. |
| 280 | Sheath | A passageway in the panel 200 through which the |
| | | wire assembly 300 is positioned. In a preferred |
| | | embodiment of the apparatus 100, there is a sheath |
| | | 280 at the top of the panel 200 and at the bottom of |
| | | the panel 200. The sheath 280 can be comprised of |
| | | any material 50, but in a preferred embodiment the |
| | | sheath 280 is comprised of the same material 50 as |
| | | the covering 260. |
| 282 | Fabric Sheath | A sheath 280 comprised of the fabric 54 making up |
| | | the fabric covering 262. |
| 290 | Panel Fastener | Means any means for supporting and reinforcing the |
| | | connection between two panels 200. Examples of |
| | | fasteners 450 can include but are not limited to hook |
| | | and loop tape, ties, adhesives, snaps, zippers, |
| | | buttons, clasps, hooks, and zippers. |
| 300 | Wire Assembly | A collection of components that are attached within a |
| | | panel 200 that provide for connecting the panels 200 |
| | | together. The wire assembly 300 can also add to the |
| | | rigidity of the apparatus 100. |
| 310 | Wire | A piece of metal positioned within and through the |
| | | length of the sheath 280 of a panel 200. |
| 350 | Mating Component | A component of the wire assembly 300 that facilitates |
| | | connecting one wire assembly 300 to another wire |
| | | assembly, and through that connection, one panel |
| | | 200 to another panel 200. |
| 360 | Receptacle | A “female” mating component 350. If a preferred |
| | | embodiment, this is comprised of a metal 52 that is |
| | | permanently affixed to the wire 310 by soldering or |
| | | other methods. |
| 370 | Protrusion | A “male” mating component 350. |
| 400 | Decorative Assembly | Decorative materials, objects, and visualizations that |
| | | are displayed and/or attached to the exterior of the |
| | | apparatus 100. A common example of a component |
| | | in the decorative assembly 400 would be a patch |
| | | 410, but virtually any illustration built into the covering |
| | | 260 or that can be attached to the covering 260 for |
| | | the purpose of visual aesthetics can constitute the |
| | | decorative assembly 400. Fabrics, bells, pom poms |
| | | bows, patches 410 etc. can be sewn, glued, printed, |
| | | or attached with decorative fasteners 450 to the |
| | | exterior surface of the apparatus 100. |
| 410 | Patch | A piece that can be permanently or merely removably |
| | | attached to the covering 260. |
| 450 | Decorative Fastener | Means any means for attaching objects to the exterior |
| | | surface of the apparatus 100, i.e. the covering 260. |
| | | Examples of fasteners 450 can include but are not |
| | | limited to hook and loop tape, ties, adhesives, snaps, |
| | | zippers, buttons, clasps, hooks, and zippers. |
| 800 | Status | A state or mode of the apparatus 100. The apparatus |
| | | can be in a fully assembled state 810, a partially |
| | | assembled/partially disassembled state 830, or a fully |
| | | disassembled state 850. |
| 810 | Assembled State | A status 800 of the apparatus 100 where the desired |
| | | number of panels 200 are mated together forming an |
| | | apparatus 100 suitable for functioning as a tree collar. |
| 830 | Partially | A status between fully assembled 810 and fully |
| | Assembled/Partially | disassembled 850. |
| | Disassembled State | |
| 850 | Disassembled State | A status 800 of the apparatus 100 where the panels |
| | | 200 of the apparatus 100 are separate for storage |
| | | purposes. |
| 900 | Method | A method for either assembling or disassembling the |
| | | apparatus 100. |
| 910 | Assembly Method | A method for putting together the apparatus 100 from |
| | | its component parts and positioning the apparatus |
| | | 100 around the base 70 of the tree 80. |
| 950 | Disassembly Method | A method for removing the apparatus 100 from the |
| | | base 70 of the tree 80 and breaking down the |
| | | apparatus 100 into its constituent parts. |

### II. Overview

The apparatus 100 uses a modular approach, where the panels 200 of the apparatus 100 are connected together the connection of wire assemblies 300 that positioned within the sheaths 280 of the panels 200.

The apparatus 100 can be efficiently stored in a disassembled state 850. The ability to stack the highly modular panels 200 takes up less space on retail shelves, in a package being shipped, or on a basement shelf in a family home. The apparatus 100 does not require hinges or folds.

The apparatus 100 can be comprised of light-weight materials 50. The apparatus 100 can be easily assembled 910 or disassembled 950 by consumers. No expensive shells or frames out of molded plastics 58 or metals 52 are required. The inner layer 250 can be comprised of plastic 58, but in a preferred embodiment a cardboard layer 252 is used. When implemented with curved panels 210, the assembly and disassembly of apparatus 100 is particularly easy and intuitive for everyday consumers as users 40 of the apparatus 100.

In a preferred embodiment, the covering 260 is comprised of fabric 54, which allows for a variety of designs that are less expensive to manufacture and require less testing. The use of fabric sheaths 282 are far superior to alternatives such as heavier, bulkier, non-compacting plastic tubes.

In a preferred embodiment, the apparatus 100 is comprised of curved panels 210 that are curved whether in a fully assembled state 810 or whether in a fully disassembled state 850. Such panels (210) can have a fabric-based or other non-molded material (50) as the covering (260), enabling the retention of the curved shape in shipping, retail, and stored environments. Such panels (210) would not include any folds.

### III. Description of Elements

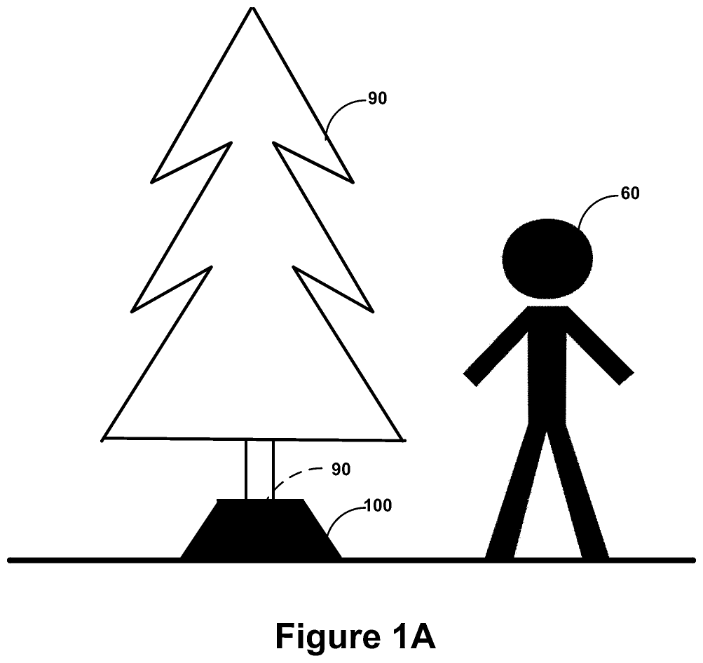

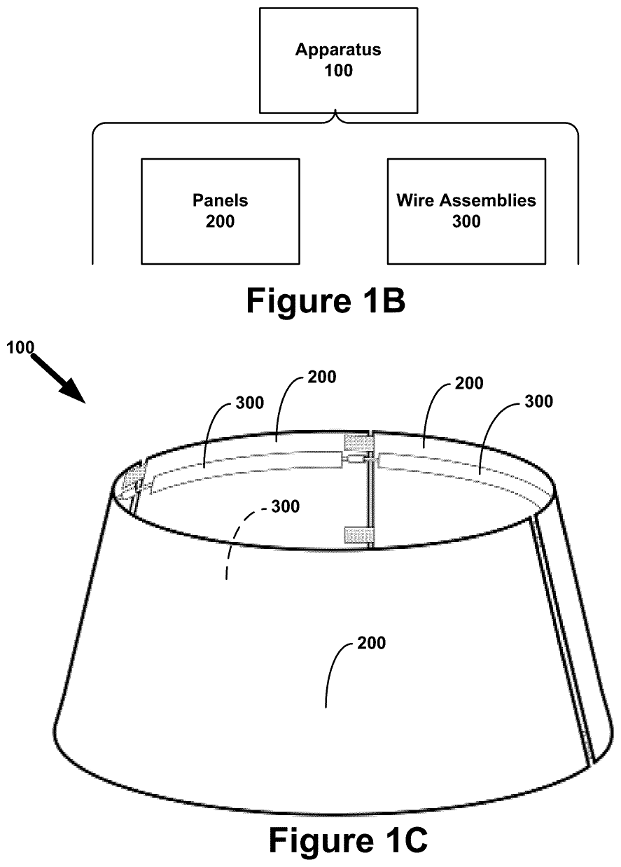

FIG. 1A is an environmental diagram illustrating an example of a tree 90 where a tree collar apparatus 100 is positioned to cover the base 80 of the tree 90. A user 40, such as typical household consumer, is can easily assemble and disassemble the apparatus 100.

FIG. 1B is a block diagram illustrating an example of the primary assemblies of the apparatus 100. The apparatus 100 is comprised panels 200 and wire assemblies 300, each of these assemblies can be comprised of a variety of different components in different variations of the apparatus 100.

FIG. 1C is a perspective view of an assembled tree collar apparatus 100. There are three panels 200 connected together by wire assemblies 300 within the sheaths 280 of the various panels 200. Different embodiments of the apparatus 100 can include different numbers of panels 200, with panels having a different number of sheaths 280, with each sheath 280 holding a wire assembly 300.

### IV. Panels

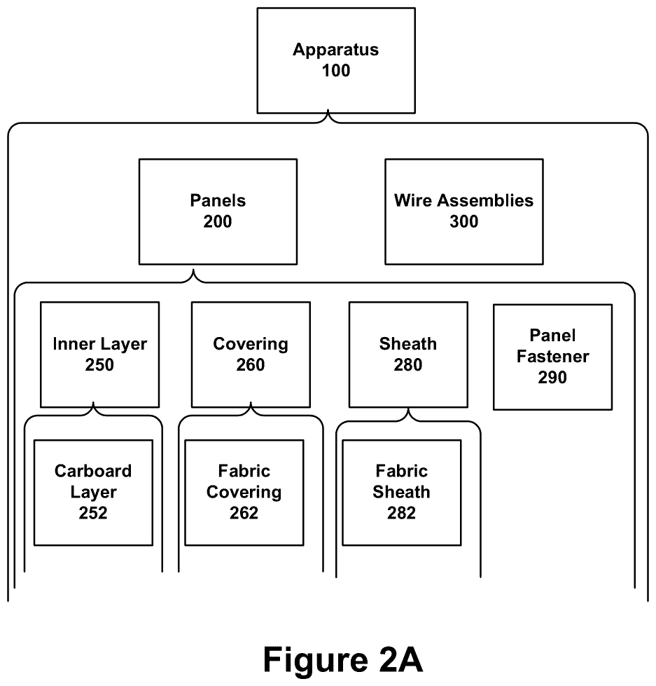

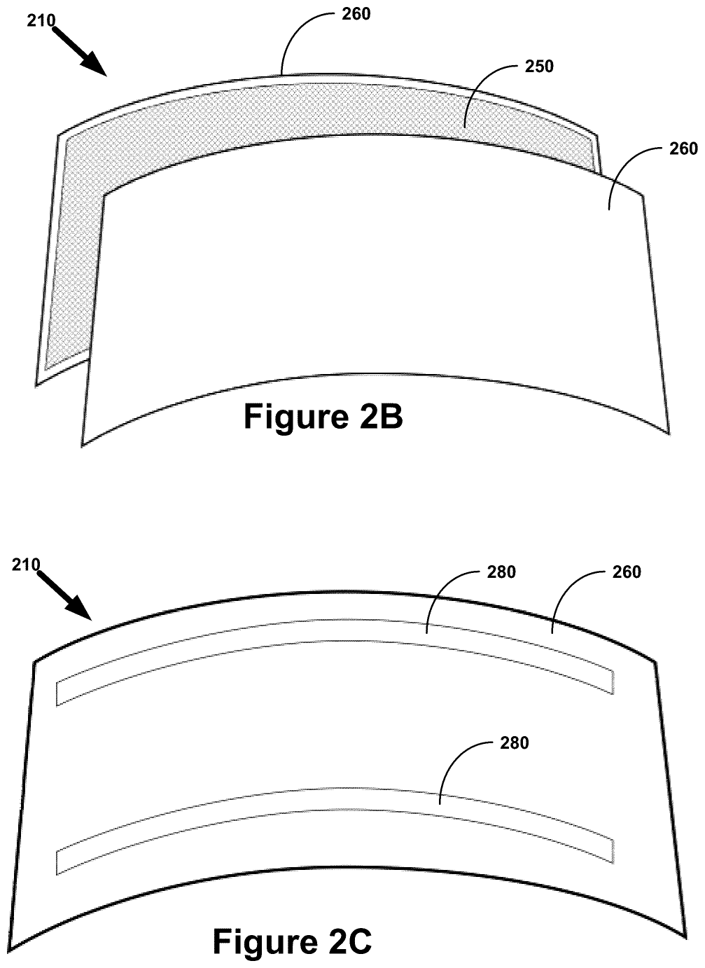

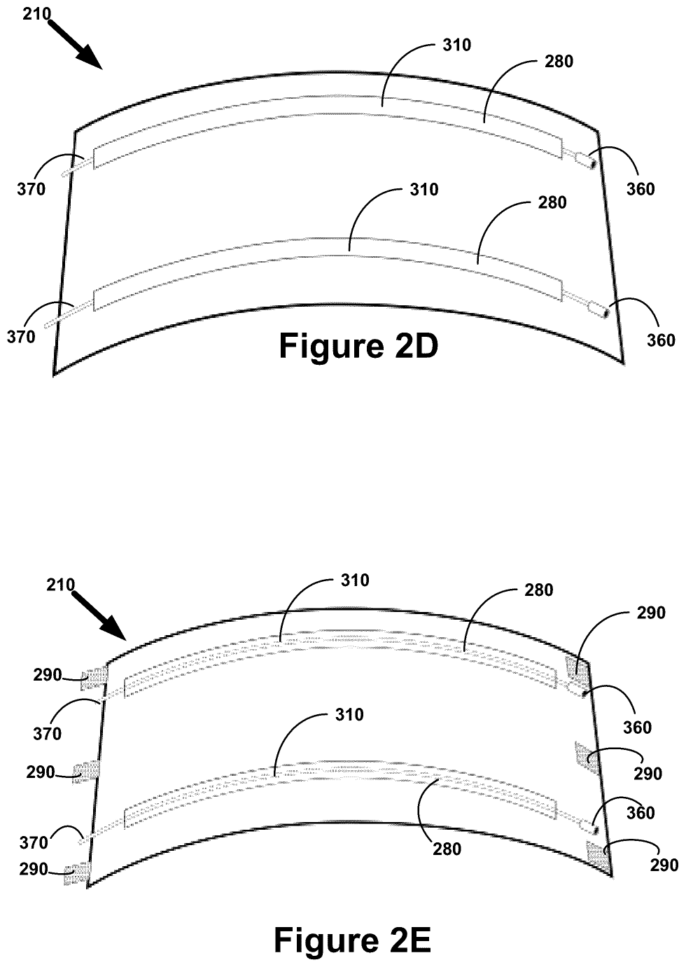

FIG. 2A is a block diagram illustrating an example of the components that can comprise the apparatus 100, particularly the components that can be included within the panels 200 of the apparatus 100. Panels 200 can include an inner layer 250, such as cardboard layer 252, a covering 260, such as a fabric covering 262, and a sheath 280, such as a fabric sheath 282. Some embodiments of the panel 200 can also include panel fasteners 290 to further secure the removable affixing of the panels 200 to each other. Some embodiments of the panels 200 will include more than one covering 260, such as one covering 260 on each side of the inner layer 250. Other embodiments may involve only a single covering 260 on the exterior facing side of the apparatus 100.

In a preferred embodiment, the panels 200 are curved panels 210. In many embodiments, the panels 200 or curved panels 210 will also be fully modular panels 220, i.e. identical to all of the other panels 200 making up the apparatus 100. This has certain advantages for assembly and storage of the apparatus 100. Curved panels 210 are useful in forming a curved shaped apparatus 100. Curved panels 210 are also useful for staking purposes. Multiple curved panels can stand independently upright on a shelf at a retail store enabling the everyday consumer to easily understand the product without expensive packaging.

FIG. 2B is a perspective view illustrating an example of a curved panel 210 comprised by an inner layer 250 encased in two coverings 260. Some embodiments of the apparatus 100 will have only one covering 260.

FIG. 2C is a perspective view illustrating an example of a curved panel 210 with two sheaths 280. Based on the curvature of the curved panel 210, the sheath 280 and the eventual wire assembly 300 held in that sheath 280 would be to the exterior of the assembled apparatus 100. However, in alternative embodiments, the curvature could be the opposite, with the sheath 280 and wire assembly being on the interior of the apparatus 100.

FIG. 2D is a perspective view illustration similar to FIG. 2C, with the difference being that the example in FIG. 2D shows wire assembly 300 components positioned within the sheaths 280. For example, protrusions 270 and receptables 360 are visible in the figure.

FIG. 2E is a perspective view illustration similar to FIG. 2D, with the difference being that the example in FIG. 2D shows the addition of panel fasteners 290 and where the wire 310 is visible through the sheath 280.

### V. Wire Assemblies

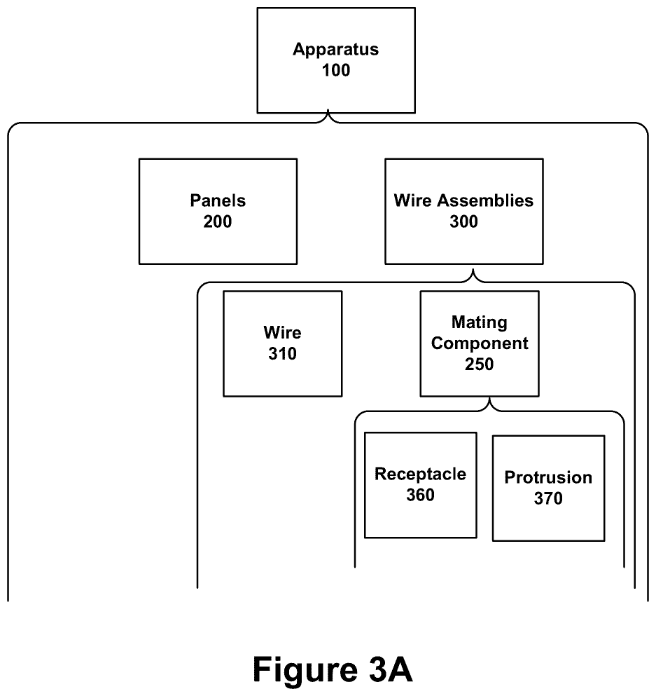

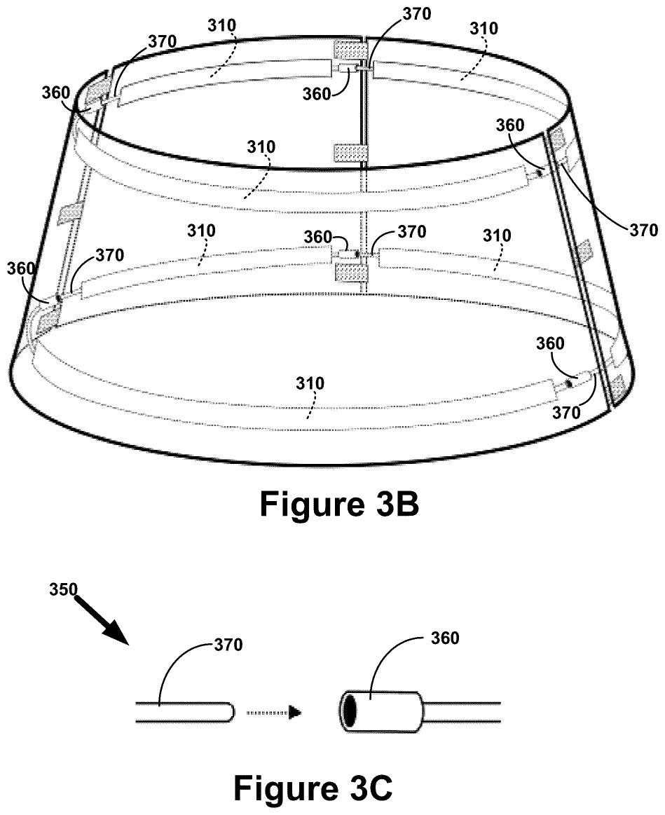

FIG. 3A is a block diagram illustration is a block diagram illustrating an example of the components that can comprise the apparatus 100, particularly the components that can be included within the wire assembly 300 of the apparatus 100. The wire assembly 300 can include a length of wire 300. It can also include a mating component 250, such as a receptable 360 that is attached to one end of the wire 310. The other end of the wire 310 may include a special protrusion 370 for mating with the receptable 360, although in some embodiments of the apparatus 100, the protrusion 370 is just the end of the wire 310.

FIG. 3B is a perspective view illustrating an example of the wire assembly 300 components on an assembled apparatus 300. FIG. 3B shows an embodiment of the apparatus 100 where there are three curved panels 210, which each curved panel 210 including two sheaths 280. One wire assembly 300 is positioned within each sheath 280, so there are six total wire assemblies 300 in the apparatus 100.

FIG. 3C is a perspective view illustrating an example of the mating components of the wire assembly 300. A protrusion 370 at the end of the wire 310 in one wire assembly 300 removably connects with the receptacle 360 at the end of a different wire 310 in a different wire assembly 300. Different embodiments of the apparatus 100 can utilized different variations for mating the wire assemblies 300.

### VI. Decorative Assemblies

In many embodiments of the apparatus 100, there will be visually decorative matter that is built into the exterior surface of the apparatus 100. The apparatus 100 does not require the use of a decorative assembly 400. For example, in an embodiment of the apparatus 100 where a fabric covering 262 is used, the fabric covering 262 include visual displays that are highly decorative and desirable to users 40. However, the apparatus 100 can also be implemented in such a manner to enable users 40 to removably attach decorative subject matter to the apparatus 100. This allows a single set of panels 200 to support a wider range and variety of decorations.

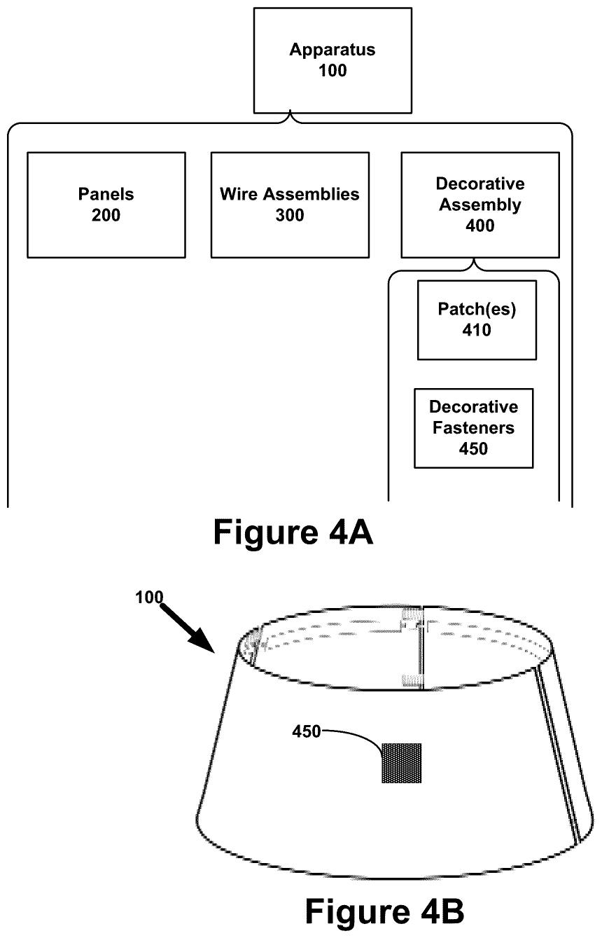

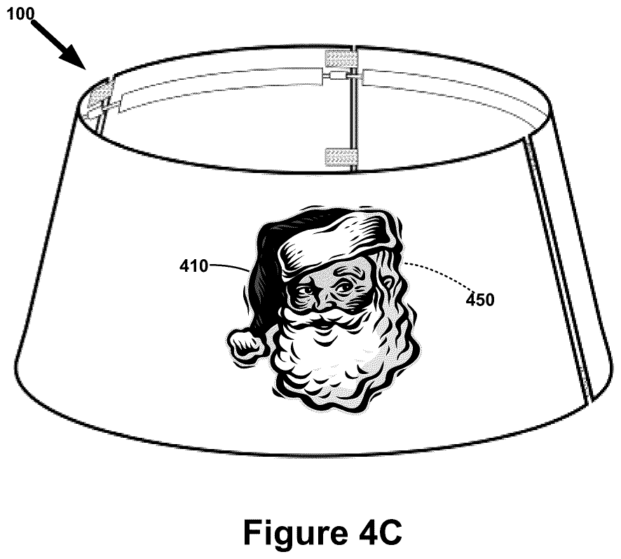

FIG. 4A is a block diagram illustrating an example of an apparatus 100 that includes an option decorative assembly 400. The decorative assembly 400 can include a wide variety of different decorative fasteners 450 and patches 410.

FIG. 4B is an environmental diagram illustrating an example of a decorative fastener 450 such as hook and loop tape (often referred to generically as “velcro”) that is attached to the exterior surface of the tree collar apparatus 100.

FIG. 4C is an environmental diagram illustrating an example of the apparatus 100 in FIG. 4B where a patch 410 is removably attached to the exterior surface of the tree collar apparatus 100. The patch 410 can include a decorative fastener 450 that corresponds to the decorative fastener 450 used on the exterior surface of the apparatus 100.

### VII. Process Views

The apparatus 100 can be implemented in a manner that makes it easy for users 40 such as everyday consumers to assemble 910 and disassemble 950 the apparatus 100. This particularly true with curved panels 210.

A. Method of Assembly/Set-Up

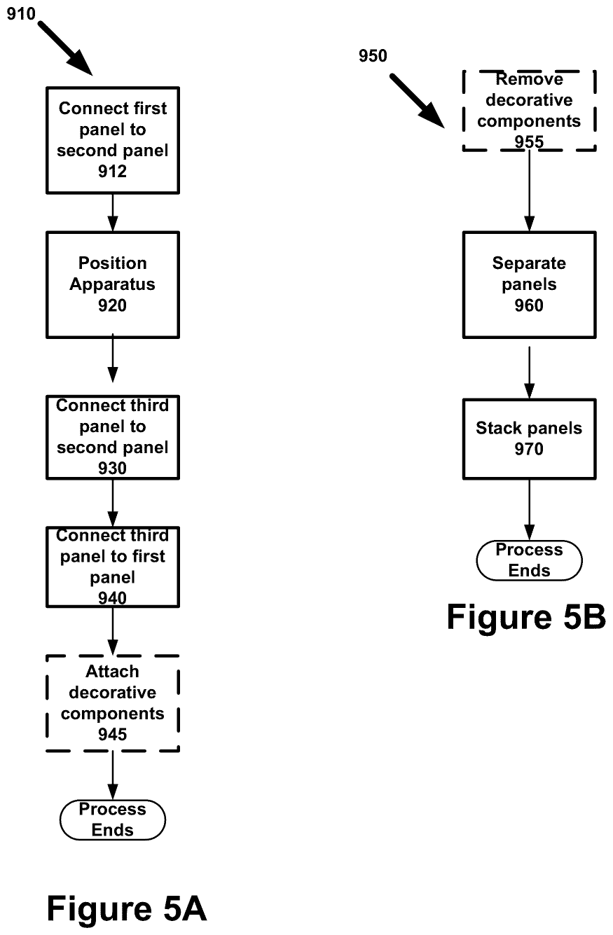

FIG. 5A is a flow chart diagram illustrating an example of a method 910 for assembling and setting up the apparatus 100.

At 912 the first panel 200 is connected to the second panel 200. This is done by connecting the wire assembly 300 from within the sheath 280 of the first panel 200 to the wire assembly 300 from within the sheath 280 of the second panel.

At 920, the two connected panels 200 can be positioned around the base 80 of the tree 90.

At 930, the third panel 200 can be connected to the second panel 200 by connecting the wire assembly 300 within the sheath 280 of the second panel 200 to the wire assembly 300 within the sheath 280 of the third panel 200.

At 940, the third panel 200 can be connected to the first panel 200 by connecting the wire assembly 300 within the sheath 280 of the first panel 200 to the wire assembly 300 within the sheath of the third panel 200.

At 945, the optional step of attaching additional decorative components 945 can be added to the exterior surface of the apparatus 100.

The various steps in FIG. 5A can be performed in different orders. For example, FIG. 5A illustrates an example where the final step of assembly at 940 is performed after the positioning of the apparatus 100 around the tree at 920. This capability exists because of the extreme ease for users 40 to assembly the apparatus 100. However, users 40 can hold on positioning the apparatus 100 until after it is fully assembled.

B. Method of Disassembly/Removal

FIG. 5B is a flow chart diagram illustrating an example of a method 950 for removing and disassembling the apparatus 100.

At 955, the optional step of removing decorative components previously added at 945 can be removed.

At 960, the panels 200 are separated from each other. This is done by separate the wire assemblies 300 positioned within the respective sheaths 280 of the panels 200.

At 970, the panels 210 can be staked on top of each other in a fully disassembled state 850. If the panels 200 are curved panels 210 and fully modular panels 220, the “footprint” of the apparatus 100 in a disassembled state 850 is significantly reduced from the corresponding footprint of the apparatus 100 in an assembled state 810.

### VIII. Alternative Embodiments

Different examples of various attributes, components, and configurations that can be incorporated into apparatus 100 are illustrated in the drawings described briefly below. No patent application can expressly disclose in words or in drawings, all of the potential embodiments of an invention. In accordance with the provisions of the patent statutes, the principles, functions, and modes of operation of the apparatus are illustrated in certain preferred embodiments. However, it must be understood that the system may be practiced otherwise than is specifically illustrated without departing from its spirit or scope.

1. An apparatus (100) adapted to cover a base (80) of a tree (90), said apparatus (100) comprising:
a plurality of panels (200) that include a plurality of sheaths (280); and
a plurality of wire assemblies (300) positioned within said plurality of sheaths (280) that removably connect said plurality of panels (200).

2. The apparatus (100) of claim 1, wherein each of said panels (200) include an inner layer (250), a covering (260) over said inner layer (252), and at least one said sheath (280) that is adapted to hold at least one of said wire assemblies (300).

3. The apparatus of claim 2, wherein said covering (260) is a fabric covering (262), and wherein said fabric covering (262) is sewn over said inner layer (250).

4. The apparatus (100) of claim 2, wherein said plurality of wire assemblies (300) are removably fixed within a plurality of said sheaths (280), and wherein said plurality of sheaths (280) are fabric sheaths (282).

5. The apparatus (100) of claim 4, wherein said inner layer (250) is a cardboard layer (252), wherein covering (260) is a fabric covering (262), and wherein said sheath (280) is a fabric sheath (282), wherein said fabric sheath (282) is sewn into said fabric covering (262).

6. The apparatus (100) of claim 2, wherein each of said panels (200) in said apparatus (100) are identical to each other.

7. The apparatus (100) of claim 6, wherein each said panel (200) includes a plurality of sheaths (280).

8. The apparatus (100) of claim 1, wherein said plurality of panels (200) include a first panel (200), a second panel (200), and a third panel (200);
wherein said plurality of wire assemblies (300) include a first wire assembly (300), a second wire assembly (300), and a third wire assembly (300);
wherein said plurality of sheaths (280) include a first sheath (280), a second sheath (280), and a third sheath (280);
wherein said first panel (200) includes said first sheath (280) and wherein said first wire assembly (300) is positioned within said first sheath (280);
wherein said second panel (200) includes said second sheath (280) and wherein said second wire assembly (300) is positioned within said second sheath (280);
wherein said third panel (200) includes said third sheath (280) and wherein said third wire assembly (300) is positioned within said third sheath (280);
wherein said first wire assembly (300) is removably connected to said second wire assembly (300), removably connecting said first panel (200) to said second panel (200); and
wherein said second wire assembly (300) is removably connected to said third wire assembly (300), removably connecting said second panel (200) to said third panel (200).

9. The apparatus (100) of claim 8, wherein said third wire assembly (300) is removably connected to said first wire assembly (300), removably connecting said third panel (200) to said first panel (200); and
wherein said plurality of panels (300) are a plurality of curved panels (210).

10. The apparatus (100) of claim 1, wherein said plurality of wire assemblies (300) include a plurality of wires (310) and a plurality of mating components (350), wherein said plurality of mating components (350) include a plurality of receptables (360) that are permanently affixed to said plurality of wires (310);
said plurality of wires (300) including a first wire (310), a second wire (310), and a third wire (310),
said plurality of receptacles (360) including first receptacle (360) permanently affixed to said first wire (310), a second receptacle (360) permanently affixed to said second wire (310), and a third receptacle (360) permanently affixed to said third wire (310);
wherein said second wire (310) is removably positioned within said first receptable (360), wherein said third wire (310) is removably positioned within said second receptable (360), and wherein said first wire (310) is removably positioned within said third receptable (360).

11. The apparatus (100) of claim 10, said plurality of panels (300) including a first panel (200), a second panel (200), and a third panel (200), said plurality of sheaths (280) including a first sheath (280) in said first panel (200) removably securing said first wire (310), a second sheath (280) in said second panel (200) removably securing said second wire (310), and a third sheath (280) in said third panel (200) removably securing said third wire (310).

12. An apparatus (100) adapted to cover a base (80) if a tree (90), said apparatus (100) comprising:
a plurality of panels (200), said plurality of panels (200) including:
a plurality of inner layers (250);
a plurality of coverings (260); and
a plurality of sheaths (280);
a plurality of wire assemblies (300), said plurality of wire assemblies (300) removably connecting said plurality of panels (200).

13. The apparatus (100) of claim 12, wherein said plurality of panels (200) are a plurality of curved panels (210);
said plurality of (100) of curved panels (210) includes a first curved panel (210), a second curved panel (210) and a third curved panel (210);
said plurality of sheaths (280) includes a first sheath (280), a second sheath (280), and a third sheath (280);
said plurality of wire assemblies (300) including a first wire assembly (300), a second wire assembly (300), and a third wire assembly (300);
wherein said first wire assembly (300) is removably secured within said first sheath (280) attached to said first curved panel (210);
wherein said second wire assembly (300) is removably secured within said second sheath (280) attached to said second curved panel (210);
wherein said third wire assembly (300) is removably secured within said third sheath (280) attached to said third curved panel (210);
wherein said first curved panel (210) is removably attached to said second curved panel (210) by said first wire assembly (300) and said second wire assembly (300);
wherein said second curved panel (210) is removably attached to said third curved panel (210) by said second wire assembly (300) and said third wire assembly (300); and
wherein said third curved panel (210) is removably attached to said first curved panel (210) by said third wire assembly (300) and said first wire assembly (300).

14. The apparatus (100) of claim 12, wherein each of said panels (200) are identical, and wherein said panels (200) are not made of molded plastics (58) or metals (52).

15. The apparatus (100) of claim 12, wherein said plurality of panels (200) are not folded.

16. The apparatus (100) of claim 12, wherein said panels (200) do not include a material (50) made of plastic (58).

17. The apparatus (100) of claim 12, said apparatus (100) further comprises a decorative assembly (400) visible on the exterior surface of said apparatus (100), wherein said decorative assembly (400) includes a removable patch (410) that is removably attached to said decorative assembly (400) by a removable fastener (450).

18. A method (910) for assembling a tree skirt apparatus (100) that is comprised of a plurality of panels (200) and a plurality of wire assemblies (300) and positioning the tree collar apparatus (100) around a base (80) of a tree (90), said method (910) comprising:
connecting (912) a first panel (200) with a first plurality of protrusions (360) and a first plurality of receptacles (370) to a second panel (200) with a second plurality of protrusions (360) and a second plurality of receptacles (370) by connecting the first plurality of protrusions (360) to the second plurality of receptables (370);
positioning (920) the connected first panel (200) and second panel (200) around the base (80) of the tree (90); and
connecting (930) a third panel (200) with a third plurality of protrusions (360) and a third plurality of receptacles (370) to the second panel (200) by connecting the second plurality of protrusions (360) to the third plurality of receptacles (370); and
connecting (940) the third panel (200) with the first panel (200) by connecting the third plurality of protrusions (360) to the first plurality of receptables (370).

19. The method (910) of claim 18, wherein the wire assemblies (300) that comprise the first, second, and third pluralities of protrusions (360) and the first, second, and third pluralities of receptables (370) are attached to a first, second, and third pluralities of wire (310) that are permanently sown in to the first, second, and third panels (200).

20. The method (910) of claim 18, wherein said first panel (200) is a curved panel (210), wherein said second panel (200) is a curved panel (210), and wherein said third panel (200) is a curved panel (210), and wherein each said curved panel (210) includes a plurality of fabric coverings (262).
